(19) United States
(12) Patent Application Publication
(10) Pub. No.: US 2011/0071069 A1
(43) Pub. Date: Mar. 24, 2011

(54) SHEAR-THINNING, DISPENSABLE LIQUID ABRASIVE CLEANSER WITH IMPROVED SOIL REMOVAL, RINSEABILITY AND PHASE STABILITY

(75) Inventors: Gregory A. Konishi, Scottsdale, AZ (US); Brenda C. Marin, Phoenix, AZ (US); Martina Spinatsch Kaiser, Phoenix, AZ (US)

(73) Assignee: The Dial Corporation, Scottsdale, AZ (US)

(21) Appl. No.: 12/956,081

(22) Filed: Nov. 30, 2010

Related U.S. Application Data
(63) Continuation-in-part of application No. 12/671,171, filed on Jan. 28, 2010.
(60) Provisional application No. 60/962,693, filed on Jul. 31, 2007.

(51) Int. Cl. C11D 17/00

(52) U.S. Cl. 510/397

(57) ABSTRACT

An improved liquid abrasive cleanser is described that shows greatly improved soil removal performance along with improved rinsing characteristics. The improved cleanser is comprised of abrasives, silica, at least one surfactant, an associative polymer thickener, a pH adjusting agent and water. The compositions of the present invention show pseudo-plastic rheology in that they shear thin upon dispensing through a bottle closure, but re-thicken on hard surfaces to provide vertical cling.

### CROSS-REFERENCES TO RELATED APPLICATIONS

This application is a continuation-in-part of application Ser. No. 12/671,171, filed Jan. 28, 2010, which was the U.S. National Phase of International Application No. PCT/US08/08990 filed Jul. 24, 2008, which claims priority to U.S. Provisional Application 60/962,693 filed Jul. 31, 2007.

### FIELD OF THE INVENTION

The present invention generally relates to hard surface cleaners and in particular to liquid abrasive cleansers comprised of inorganic abrasive, surfactant, polymer thickener and water.

### BACKGROUND OF THE INVENTION

Abrasive cleansers have been known for some time and are now common hard surface cleansers used in homes and institutions. Even more than a century ago, simple dry scouring powders such as Bon Ami® were in the marketplace. Eventually liquid abrasive cleansers emerged, giving the consumer a “pre-wetted” abrasive material rather than a dry and often dusty powder. Such liquid abrasives, sometimes called cream cleansers, include all-purpose hard surface cleansers and the specialty cleansers such as metal polishes. Early examples of liquid cleansers included silica based abrasive cleansers, cleansers with clay thickeners, and stearate soap thickened slurries described in U.S. Pat. Nos. 3,985,668, 4,005,027 and 4,051,056 (Hartman), U.S. Pat. No. 4,352,678 (Jones, et al.), and U.S. Pat. No. 4,240,919 (Chapman). These versions of liquid abrasive cleansers had serious settling problems, often resulting in separation of a free liquid layer residing at the top of the product and a compacted sediment layer at the bottom. Such instability, or syneresis, is problematic for the end-user. Shaking of the liquid product is required prior to each use, and if the compacting of the sediment is severe, even shaking cannot restore the homogeneity of the abrasive suspension. Often the consumer doesn't read the label instructions to “shake before use” or otherwise doesn't think to shake the contents, only to be surprised to find clear thin liquid dispensed from the bottle of abrasive cleanser.

Many improvements to liquid abrasive cleansers have been described over the years. For example, U.S. Pat. No. 4,869,842 (Denis, et al.) describes an abrasive cleanser with improved degreasing performance through use of non-polar degreasing solvents. Allan also describes the use of degreasing hydrocarbon solvents in abrasive cleansers in PCT application WO98/49261.

U.S. Pat. No. 5,470,499 (Choy, et al.) describes a bleach-containing abrasive cleanser with improved cleaning performance, improved rinsing and improved physical stability through use of a high-molecular weight cross-linked polyacrylate polymer.

U.S. Pat. Nos. 5,529,711 and 5,827,810 (Brodbeck, et al.) describe bleach-containing abrasive cleansers with improved stabilities also possible through the use of cross-linked polyacrylates.

U.S. Pat. No. 5,821,214 (Weibel) describes an improved liquid abrasive cleanser comprising very high molecular weight cross-linked polyacrylates along with smectite clays for stability.

Lastly, U.S. Pat. No. 6,511,953 (Fontana, et al.) describes an abrasive cleanser with improved cleaning performance comprising both a nonionic surfactant and a sulfate anionic surfactant.

In spite of the developments over many years, liquid abrasive cleansers still have problems with cleaning performance, phase stability and rinseability. Indeed, previous formulations only showed optimization of one or at most two of these three essential attributes, as any pairs of these three attributes tended to be inversely related and any performance attribute needs to be optimized against cost. For example, to increase cleaning performance on bathroom soap scum, additional abrasive can be added, but that also results in poorer rinsing and unacceptable stability. Additional surfactant for improved cleaning and better abrasive suspension adds significant cost. Although some improvement was achieved by the use of cross-linked polyacrylates, (described by Choy), these polymers are expensive, difficult to handle and disperse and have questionable sustainability. Additionally, the formulas described in the past by Choy do not have acceptable long-term shelf stability, free-rinsing characteristics, or superior cleaning against a variety of soils such as rust and bathroom soap scum. Lastly, there are no high-performance liquid abrasive cleansers described in the prior art that show shear-thinning capability such that they can be easily squirted from a deformable package comprising an orifice yet cling to a vertical surface to be cleaned. To date, cream cleansers with high abrasive content are too unstable and do not display shear-thinning rheology to be easily dispensable by the consumer.

For these reasons there is still a need to explore new combinations of surfactant, polymer and abrasive ingredients that may provide for a low cost liquid abrasive cleanser that shows superior cleaning performance, cleaner rinsing, and both high and low-temperature storage stability. Of ultimate need is to find a liquid abrasive cleanser with not only these attributes, but which also may be squirted from various dispensing packaging.

### BRIEF SUMMARY OF THE INVENTION

In an exemplary embodiment, the present invention is an improved liquid abrasive cleanser that shows superior cleaning performance, clean rinsing characteristics and excellent storage stability, along with a shear-thinning, pseudo-plastic rheology profile that allows for controlled dispensing with resulting vertical cling of the product on surfaces to be cleaned.

In another exemplary embodiment of the present invention, an improved liquid abrasive cleanser composition comprises a non-cross linked associative polymer thickener, a water-dispersible nonionic surfactant, a pH adjusting agent, an abrasive, and water. Remarkably, and completely opposite the teaching recited in the prior art, cross-linked polymers are not required for storage/phase stability of liquid abrasive cleansers. “Non cross-linked” polymers, such as the associative thickeners used herein, not only provide the storage stability against syneresis but also provide a shear-thinning pseudo-plastic rheology that allows for easy dispensing and vertical cling. This is heretofore unknown and untaught in the prior art.

In another exemplary embodiment of the present invention, an improved liquid abrasive cleanser composition comprises a non-cross linked associative polymer thickener, silica, a water-dispersible nonionic surfactant, a pH adjusting agent, an abrasive, and water. The addition of silica further stabilizes the composition, improves the overall rheological profile, and gives an unexpected cleaning performance benefit.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention. Various changes to the described embodiments may be made, for example in the function and relative amounts of the ingredients described without departing from the scope of the invention as set forth in the appended claims. Additionally, though described herein in general terms of a liquid abrasive cleanser that may be poured from a container or dispensed from a bottle (such as a deformable plastic bottle equipped with a suitable restrictive orifice or resilient valve closure), other embodiments of the invention such as wipes, pads, sponges or other cleaning implements/tools that are pre-wetted/treated or otherwise impregnated with some quantity of the liquid abrasive cleanser compositions described herein are within the scope of the present invention.

That being said, the present invention comprises improved liquid abrasive cleansers made possible by two significant departures from the prior art thinking, namely (1) the use of associative co-polymer thickener in place of cross-linked polyacrylates, and (2) the use of water-dispersible nonionic surfactants in place of water-soluble surfactants. The use of an associative co-polymer provides the pseudo-plastic rheology and the product viscosity, and aids in stability of the abrasive suspension in both hot and cold storage conditions, whereas the use of water-dispersible surfactants provides for easier and cleaner rinsing of the product from the cleaned surfaces with less visible abrasives residue remaining. Addition of silica unexpectedly improves the stability of this high solids matrix, improves overall rheology, and gives a surprising improvement in soap scum removal.

The compositions of the present invention minimally comprise an associative co-polymer, silica, a water-dispersible nonionic surfactant, a pH adjustment agent, an abrasive and water. More preferred and more specifically, the compositions of the present invention preferably comprise an anionic associative co-polymer, silica, at least one water-dispersible nonionic surfactant, calcium carbonate, crystalline silica sand and/or clay abrasives or combinations thereof, a pH adjusting agent (e.g., preferably alkali metal hydroxides, amines, alkanolamines or the like), and water, and optionally may comprise the usual halogen or peroxygen bleach, colorants, fragrances and preservatives that are typically used in hard surface cleaners and cleansers alike.

The Associative Copolymer

Associative copolymers are water-soluble or water/alkali swellable polymer emulsions (ASE) that have covalently bonded hydrophobic moieties that are capable of non-specific hydrophobic associations. These materials are often referred to as “rheology modifiers”, “associative thickeners” or more precisely, “hydrophobically modified alkali soluble/swellable emulsions” (or HASE).

The preferred associative co-polymers for use in the present invention are water-soluble and impart pseudo-plastic characteristics to the liquid abrasive cleanser compositions after the co-polymer is neutralized in the mixture to a pH of 7 or more with the excess of alkaline abrasives such as carbonate, and/or with an added pH adjusting agent(s) such as hydroxide, amines, alkanolamines and similar alkaline materials. Such associative co-polymers are available in the form of an acidic aqueous emulsion or dispersion that is subsequently neutralized in the mixing batch process to an alkaline pH in order to thicken and stabilize the slurry compositions.

Some associative co-polymers preferred herein are polymers comprised of three components: (1) a monoethylenically unsaturated monocarboxylic acid or dicarboxylic acid of from about 3 to 8 carbon atoms, typically acrylic acid or methacrylic acid, (2) a monoethylenically unsaturated co-polymerizable monomer, typically methyl acrylate or ethyl acrylate to construct the polymeric backbone, and (3) a monomer with surfactant properties to impart the pseudo-plastic thickening character to the final co-polymer. Associative co-polymers for use in the present invention are more preferably anionic or nonionic in character, and most preferably anionic. Nonionic associative rheology modifiers tend to be more useful in acidic or cationic formulations and are thus not preferred herein. Nonionic associative thickeners include the hydrophobically modified, ethoxylated urethane resins (HEUR).

That being said, the associative thickeners for use in the compositions of the present invention include the hydrophobically modified alkali soluble emulsions described in U.S. Pat. No. 4,351,754 (Dupré), incorporated herein in its entirety by reference. These thickening agents are comprised of three monomers: (1) a monoethylenically unsaturated monocarboxylic acid or dicarboxylic acid of from about 3 to 8 carbon atoms, typically acrylic acid or methacrylic acid, (2) a monoethylenically unsaturated acrylate ester, typically methyl acrylate or ethyl acrylate, and (3) an acrylic, or methacrylic, ethoxylated ester with general structure: H₂C═C(R)—C(O)—O—(CH₂—CH₂O)ₙ—R′, where R is either H (acrylic) or CH₃ (methacrylic), R′ is C₈-C₂₄ and n is at least 2 and up to about 70. These hydrophobically modified alkali-soluble acrylic emulsion polymers are available under the trademark “Acusol®” from Rohm and Haas/Dow Chemical Co. Especially preferred associative co-polymers include, but are not limited to, Acusol® 820 (a hydrophobically modified anionic thickener, 30% active emulsion polymer of 40% methacrylic acid, 50% ethylacrylate and 10% stearyl oxypolyethylmethacrylate having approximately 20 moles of ethylene oxide), Acusol® 823 (an anionic, 30% active emulsion polymer composed of 44% methacrylic acid, 50% ethyl acrylate and 6% stearyl oxypolyethylmethacrylate having approximately 10 moles of ethylene oxide), and DW-1206A (a 30% active anionic emulsion polymer with 44% methacrylic acid, 50% ethyl acrylate and 6% stearyl methacrylate polymer having about 10 moles of ethylene oxide), each from Rohm and Haas. Less preferred are any of the cross-linked thickeners, such as Acusol® 810A (18% solids, cross-linked, anionic, associative thickener). Precise knowledge of the structure of these co-polymers is often elusive to the end formulator, since some of the supplier literature is proprietary, or at the very least, somewhat nondescript, and thus the chemical and structural composition of the co-polymers of use herein are not claimed with certainty. Additionally preferred associative co-polymers may include the anionic associative co-polymers Rheovis® ATA and ATS from CIBA, Alcoguard® 5800, and Alcogum® L-11, L-12, L-15, SL-117, SL-70, and SL-78 from Alco Chemical. Also tested, but not preferred, include Rheovis® ADP (a branched, cross-linked polymer from CIBA), Rheovis® ATN (a non-associative polyacrylate rheology modifier from CIBA), Rohagit® SD 15 from PolymerLatex, GmbH, (a 30% active aqueous dispersion of a thermoplastic methacrylic acid-acrylic ester co-polymer), and the cationic Rheovis® polymers CSP, CDE, CDP, CR, and CRX from CIBA.

The associative co-polymer is typically used in an amount of from about 0.01% to about 1.0% by weight, and more preferably in an amount of from about 0.05% to about 0.50% by weight active co-polymer, based on the total weight of the abrasive cleanser composition. Mixtures of associative co-polymers may be used to obtain the desired rheological characteristics and stability of a liquid abrasive cleanser composition. As mentioned, use of an associative co-polymer thickener imparts stability to the suspension having high levels of abrasive, yet also allows the formulations to be squirted from a deformable plastic bottle having a restrictive opening to then re-thicken upon contact with the surface to be cleaned. Most preferred is to incorporate from about 0.05 wt. % to about 0.50 wt. % active Acusol® 820 (i.e. from about 0.17 wt. % to about 1.7 wt. % of the 30% active emulsion polymer comprising approximately 40% methacrylic acid, 50% ethylacrylate and 10% stearyl oxypolyethylmethacrylic having approximately 20 moles of ethylene oxide) to total weight of the spray abrasive composition.

The Silica

The silica for use in the present invention may be any fumed silica, provided in solid form or dispersed form, or any other synthetic amorphous silica. Commercially available fumed silica (or silica fume) may be formed from the conversion of silicon tetrachloride with hydrogen and oxygen in the gas phase (e.g. flame process). Commercial fumed silica is sub-micron (e.g. nanometer), very pure silicon dioxide (SiO₂). It may be purchased under the trade names Aerosil® by Evonik-Degussa and Cab-O-Sil® from Cabot Corp. Particularly useful for the abrasive cleansers of the present invention are both the hydrophilic and hydrophobic fumed silica, including but not limited to hydrophilic silica Aerosil® 130, Aerosil® 200, Aerosil® 200-SP, Aerosil® 300, Aerosil® 380, and Aerosil® OX-50, and the hydrophobic silica Aerosil® R972, Aerosil® R974, Aerosil® R104, Aerosil® R106, Aerosil® R202, Aerosil® R805, Aerosil® R812, Aerosil® R812S, Aerosil® R7200, Aerosil® R8200, and Aerosil® R9200. Fumed silica traditionally finds use in liquids for rheology control, suspension, moisture resistance, viscosity stability and emulsification. The most useful fumed silica for use in the present invention, and the silica that is used more frequently for rheological improvement, include Aerosil® 130, Aerosil® 200, Aerosil® 300, Aerosil® 380, Aerosil® R972, Aerosil® R974, Aerosil® R812, Aerosil® R812S, Aerosil® R202, Aerosil® R805, and Cab-O-Sil® M5. The most preferred fumed silica for use in the present invention includes Aerosil® 200, (a 200 m²/g surface area hydrophilic SiO₂), Cab-O-Sil® M5, (untreated fumed silica with 200 m²/g surface area), and Aerosil® 300, (a 300 m²/g surface area hydrophilic SiO₂), and mixtures thereof.

Dispersed silica also finds use in the present invention and may offer an easier to handle alternative to the powdered form of fumed silica raw material, depending on the capabilities of the manufacturing plant. The most preferred for use herein are the alkaline silica dispersions available from Evonik-Degussa under the Aerodisp® brand. These include, but are not limited to, Aerodisp® W 7520, W 7520N, W 7520 P, W 7622, W 1226, W 7330 N, W 1813, and VP Disp. W 1250, VP Disp. WR 8520, and VP Disp. W 7225P. The most preferred dispersed silica for use herein is the raw material Aerodisp®W 7520 N, which is a 20 wt. % solids dispersed SiO₂, stabilized at pH 9.5-10.5 with sodium hydroxide.

Also of use for the sprayable abrasive compositions of the present invention is any amorphous precipitated SiO₂. Precipitated silica is generally formed from the reaction of sodium silicate with mineral acids, as disclosed in U.S. Pat. No. 5,447,704 (Aldcroft, et al.), incorporated herein in its entirety by reference. Such silica is available from a variety of suppliers in a number of grades, including but not limited to the Zeosil® and Tixosil® brands of silica from Rhodia and the Trusil® brand of silica from Westco.

Regardless of the source of the silica, (fumed/powder, fumed/dispersed, or amorphous/precipitated), the preferred level of silica for rheologically modifying the present invention is from about 0.01 wt. % to about 1.0 wt. % active SiO₂ to total weight of the composition. More preferred is to incorporate about 0.1 wt. % to about 0.5 wt. % active SiO₂ in the sprayable abrasive composition. Most preferred is to use Aerosil® 300 fumed silica or Aerodisp® W 7520 N dispersed silica at the level necessary for about 0.1% to about 0.5 wt. % active SiO₂ within the finished cleaning composition.

The Surfactant

The surfactant for use in the liquid abrasive cleanser compositions of the present invention may include various anionic or nonionic materials or combinations thereof, although it is preferred to use nonionic surfactants. Most preferred is to utilize at least one nonionic surfactant that is water-dispersible, however combinations of more than one nonionic surfactant or various combinations of nonionic and anionic surfactants may find use in the present invention.

Preferred nonionic surfactants for use in the present compositions are the ethoxylated aliphatic alcohols. These materials are particularly good at removing oily soils from surfaces, e.g. oily bathroom shower/tub soils, and these may be naturally derived. For example, the cleanser compositions herein may contain ethoxylated primary alcohols represented by the general formula R—(OCH₂CH₂)ₓ—OH, where R is C₁₀ to C₁₈ fatty alcohol chain length, preferably bio-sourced rather than petroleum sourced, and where x is on average from 4 to 12 mol of ethylene oxide (EO). Combinations of more than one alcohol ethoxylate surfactant may also be desired in the liquid abrasive cleanser composition in order to maximize cleaning performance, stability and rinseability profile.

Preferred nonionic surfactants for use in the present invention include; Tomadol® 1-73B (HLB 11.8); Tomadol® 400 (HLB 8.9); Tomadol® 600 (HLB 10.7); Tomadol® 900 (HLB 13.1); Tomadol® 901 (HLB 12.1); Tomadol® 910 (HLB 11.8) available from Air Products; Neodol® 45-7, Neodol® 25-9, or Neodol® 25-12 from Shell Chemical Company; and Surfonic® L24-7 and Surfonic® L24-12 available from Huntsman. Most preferred for use in the present invention are the water-dispersible Tomadol® surfactants having HLB of about 10 or greater, such as Tomadol® 600.

The abrasive compositions of the present invention may also include additional nonionic surfactant such as the alkyl polyglycoside surfactants. The alkyl polyglycosides (APGs) also called alkyl polyglucosides if the saccharide moiety is glucose, are naturally derived, nonionic surfactants. The alkyl polyglycosides that may be used in the present invention are fatty ester derivatives of saccharides or polysaccharides that are formed when a carbohydrate is reacted under acidic condition with a fatty alcohol through condensation polymerization. The APGs are typically derived from corn-based carbohydrates and fatty alcohols from natural oils in animals, coconuts and palm kernels. The alkyl polyglycosides that are preferred for use in the present invention contain a hydrophilic group derived from carbohydrates and is composed of one or more anhydroglucose units. Each of the glucose units can have two ether oxygen atoms and three hydroxyl groups, along with a terminal hydroxyl group, which together impart water solubility to the glycoside. The presence of the alkyl carbon chain leads to the hydrophobic tail to the molecule. When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of varying concentration of glucose units (or degree of polymerization).

The APG's that may be used in the abrasive cleanser compositions of the present invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APGs, x may be a noninteger on an average basis when referred to APG used as an ingredient for the compositions of the present invention. For the APGs of use in the compositions of the present invention, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred for use in the present compositions are APGs with an average degree of polymerization of from 1.4 to 1.7 and the chain lengths of the aliphatic groups are between C₈ and C₁₆. For example, one preferred APG for use herein has chain length of C₈ and C₁₀ (ratio of 45:55) and a degree of polymerization of 1.7. These alkyl polyglycosides are also biodegradable in both anaerobic and aerobic conditions and they exhibit low toxicity to plants, thus improving the environmental profile of the present invention. The liquid abrasive cleanser compositions may include a sufficient amount of alkyl polyglycoside surfactant in an amount that provides a desired level of hard surface cleaning and rinseability.

The preferred total level of nonionic surfactant in the liquid abrasive cleanser of the present invention is from about 0.1% to about 20% by weight of the composition and more preferably from about 1% to about 10%. As mentioned, the nonionic surfactant component may be a single surfactant (e.g., just one alcohol ethoxylate) or blends of similar types of materials (e.g., at least one alcohol ethoxylate), or may be blends of dissimilar nonionic materials, (e.g., blends of alcohol ethoxylate and alkylpolyglycoside). As mentioned the most preferred surfactants for use in the present invention are the water-dispersible alcohol ethoxylate nonionic surfactants available from Air Products under the brand name Tomadol®. Most preferred is to incorporate one or more of these particular alcohol ethoxylates at from about 1% to about 5% by weight actives in the composition.

Anionic surfactants may also find use in the abrasive cleansers of the present invention, preferably as a surfactant mixture with at least one nonionic surfactant described above. Anionic surfactants that may find use in the abrasive cleansers of the present invention include the sulfates and sulfonates. Most preferred anionic surfactants include the alkyl sulfates, also known as alcohol sulfates. These surfactants have the general formula R—O—SO₃Na where R is from about 10 to 18 carbon atoms, and these materials may also be denoted as sulfuric monoesters of C₁₀-C₁₈ alcohols, examples being sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petro-chemical basis, these sulfates possessing degradation properties similar to those of the corresponding compounds based on fatty-chemical raw materials. From a detergency/cleaning standpoint and for stability of the abrasives suspension, C₁₂-C₁₆-alkyl sulfates and C₁₂-C₁₅-alkyl sulfates, and also C₁₄-C₁₅ alkyl sulfates, are preferred. In addition, 2,3-alkyl sulfates, which may for example be obtained as commercial products from Shell Oil Company under the brand name DAN®, are suitable anionic surfactants. Most preferred is to use powdered or diluted liquid sodium lauryl sulfate from the Stepan Company, recognized under the trade name of Polystep®. The preferred level of alcohol sulfate in the present invention is from about 0.1% to about 20%. Most preferred is from about 1% to about 10% as determined on an actives basis.

Also with respect to the anionic surfactants useful in the liquid abrasive cleanser compositions of the present invention, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 16 mol of ethylene oxide (x=0.5 to 16 EO), such as C₁₂-C₁₈ alcohols containing from 0.5 to 16 EO, and where M is alkali metal or ammonium, alkyl ammonium or alkanol ammonium counterion. Preferred alkyl ether sulfates for use in one embodiment of the present invention are C₈-C₁₈ alcohol ether sulfates with a degree of ethoxylation of from about 0.5 to about 16 ethylene oxide moieties and most preferred are the C₁₂-C₁₅ alcohol ether sulfates with ethoxylation from about 4 to about 12 ethylene oxide moieties. It is understood that when referring to alkyl ether sulfates, these substances are already salts (hence “sulfate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. The preferred level of C₁₂-C₁₈/0.5-9EO alkyl ether sulfate in the present invention is from about 0.1% to about 20%. Most preferred is from about 1% to about 10% on an actives basis.

Other surfactants that may find use in the present compositions include sulfonate types such as the C₉₋₁₃ alkylbenzenesulfonates, olefinsulfonates, i.e. mixtures of alkenesulfonates and hydroxyalkanesulfonates and also disulfonates, as are obtained, for example, from C₁₂₋₁₈-monoolefins having a terminal or internal double bond by sulfonating with gaseous sulfur trioxide followed by alkaline or acidic hydrolysis of the sulfonation products. Sulfonates that may find use in the cleanser compositions of the present invention include the alkyl benzene sulfonate salts. Suitable alkyl benzene sulfonates include the sodium, potassium, ammonium, lower alkyl ammonium and lower alkanol ammonium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft®LPS-99 or Calsoft®TSA-99 marketed by the Pilot Chemical Company. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of use in the present invention are the ammonium salts, lower alkyl ammonium salts and the lower alkanol ammonium salts of linear alkyl benzene sulfonic acid, such as triethanol ammonium linear alkyl benzene sulfonate including Calsoft® T-60 marketed by the Pilot Chemical Company. The preferred level of sulfonate surfactant in the present invention is from about 0.1% to about 20%. Most preferred is to use sodium dodecylbenzene sulfonate at a level of from about 1% to about 10% by weigh on an actives basis to the total composition.

Additional anionic materials that may be necessary for improved detergency and phase stability and improved rinseability include the salts of alkylsulfosuccinic acid, which are also referred to as sulfosuccinates or as sulfosuccinic esters and which constitute the monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants. Particular preference is given in turn to sulfosuccinates whose fatty alcohol radicals are derived from ethoxylated fatty alcohols having a narrowed homolog distribution. The anionic sulfosuccinate surfactant may be present in the composition in a range from about 1% to about 50% by weight of the composition, more preferably 3% to 20% by weight of composition.

The compositions of the present invention may also include fatty acid soaps as an anionic surfactant ingredient. The fatty acids that may find use in the present invention may be represented by the general formula R—COOH, wherein R represents a linear or branched alkyl or alkenyl group having between about 8 and 24 carbons. It is understood that within the compositions of the present invention, the free fatty acid form (the carboxylic acid) will be converted to the carboxylate salt in-situ (that is, to the fatty acid soap), by the excess alkalinity present in the composition from added pH adjusting agent and/or the abrasives. As used herein, “soap” means salts of fatty acids. Thus, after mixing and obtaining the compositions of the present invention, the fatty acids will be present in the composition as R—COOM, wherein R represents a linear or branched alkyl or alkenyl group having between about 8 and 24 carbons and M represents an alkali metal such as sodium or potassium. The fatty acid soap is preferably comprised of higher fatty acid soaps. The fatty acids that are added directly into the compositions of the present invention may be derived from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Although fatty acids can be synthetically prepared, for example, by the oxidation of petroleum, or by hydrogenation of carbon monoxide by the Fischer-Tropsch process, the naturally obtainable fats and oils are preferred. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids. Preferred salts of the fatty acids are alkali metal salts, such as sodium and potassium or mixtures thereof and, as mentioned above, preferably the soaps generated in-situ by neutralization of the fatty acids with excess alkali also added to the compositions. Other useful soaps are ammonium and alkanol ammonium salts of fatty acids, most particularly the monoethanolammonium fatty soap prepared in situ by the neutralization of a fatty acid with monoethanolamine (MEA). The fatty acids that may be included in the present compositions will preferably be chosen to have desirable detergency, rinseability and suspension stabilizing effects. Fatty acid soaps may be incorporated in the compositions of the present invention at from about 1% to about 10%.

The pH Adjusting Agent

As mentioned above, HASE thickeners normally require pH adjustment from acidic pH to alkaline pH in order to achieve the desired thickening, stabilizing and rheology effects. Although the abrasive cleanser compositions of the present invention include an excess of alkaline abrasives such as calcium carbonate, it is more efficient to add a separate alkaline material that is more water soluble to neutralize the associative thickener and adjust the composition to a desired final alkaline pH. Such materials may be any alkali metal or alkaline earth hydroxide, (e.g., NaOH, KOH, Mg(OH)₂, and the like), or ammonia/ammonium hydroxide (NH₃, NH₄OH), any alkylamine (primary, secondary or tertiary amine), or any alkanolamine (monoethanolamine, diethanolamine, or triethanolamine, for example). Besides these, other alkaline materials may be used including soluble carbonates, sesquicarbonates, bicarbonates, borates, citrates, silicates, and such. Preferred pH adjusting agents for use in the present invention include but are not limited to sodium hydroxide (NaOH), potassium hydroxide (KOH), magnesium hydroxide (Mg(OH)₂), ammonium hydroxide, ammonia, primary amines, secondary amines, tertiary amines, monethanolamine (MEA), diethanolamine (DEA), triethanolamine (TEA), sodium carbonate (Na₂CO₃), potassium carbonate (K₂CO₃), sodium bicarbonate (NaHCO₃), potassium bicarbonate (KHCO₃), sodium sesquicarbonate (Na₂CO₃.NaHCO₃.2H₂O), sodium silicate (SiO₂/Na₂O), sodium borate (Na₂B₄O₇—(H₂O)₁₀ or “borax”), monosodium citrate (NaC₆H₇O₇), disodium citrate (Na₂C₆H₆O₇), and trisodium citrate (Na₃C₆H₅O₇), and mixtures thereof. Most preferred is to use monoethanolamine (MEA) to adjust the pH of the liquid abrasive cleanser compositions of the present invention to at least pH=10. The pH-adjusting agent is typically incorporated at from about 0.01% to about 1.0%, or at the level necessary to bring the composition to an alkaline pH target of greater than 10. More or less alkaline material may be added to achieve the target if, for example, there are greater or lesser amounts of associative thickener to neutralize, and whether or not there is a surfactant to neutralize (e.g., a sulfonic acid requiring neutralization to a sulfonate, or a free fatty acid requiring neutralization to a fatty acid soap). Selection of pH adjusting agent may also be influenced by the optional presence of halogen or oxygen bleach in the liquid abrasive cleanser, (for example, avoiding the use of ammonia or amines when hypochlorite bleach is present and recognizing that trade bleach is quite alkaline due to free sodium hydroxide present).

That being said, the target pH for the final composition is preferably greater than 7 and most preferably greater than 10. It is preferable to achieve that target pH using monoethanolamine (MEA) at a level of from about 0.1% to about 0.5% by weight of the total composition.

The Abrasive

Abrasives are incorporated in the present invention to promote cleaning action by providing scouring when the liquid cleansers of the invention are used on hard surfaces. Preferred abrasives include calcium carbonate, but other abrasives such as silica sand, perlite, which is expanded silica, and various other insoluble, inorganic particulate abrasives can be used, such as quartz, pumice, feldspar, talc, labradorite, melamine granules, urea formaldehyde, tripolyphosphates and calcium phosphate. Most preferred is to use calcium carbonate and in amounts ranging from about 5% to 70% and more preferably between about 25% and 40% by weight of the composition.

Optional Solvent

Also useful in the present invention are one or more solvents. Solvents may assist with cleaning performance and rinseability and in particular may be used to help dissolve greasy bathroom soils derived from body wash emollients. Solvents that may be included in the present abrasive cleanser compositions include ethanol, isopropanol, n-propanol, n-butanol, MP-Diol (methylpropanediol), ethylene glycol, propylene glycol, and other small molecular weight alkanols, diols, and polyols, ethers, and hydrocarbons (e.g. terpenes), and mixtures thereof, that may assist in cleaning when used at a level of from about 0.5% to about 5%. Satisfactory glycol ethers for use in the present compositions include ethylene glycol monobutyl ether (butyl cellosolve), diethylene glycol monobutyl ether (butyl carbitol), triethylene glycol monobutyl ether, mono, di, tri propylene glycol monobutyl ether, tetraethylene glycol monobutyl ether, mono, di, tripropylene glycol monomethyl ether, propylene glycol monomethyl ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono, di, tripropylene glycol monoethyl ether, mono, di tripropylene glycol monopropyl ether, mono, di, tripropylene glycol monopentyl ether, mono, di, tripropylene glycol monohexyl ether, mono, di, tributylene glycol mono methyl ether, mono, di, tributylene glycol monoethyl ether, mono, di, tributylene glycol monopropyl ether, mono, di, tributylene glycol monobutyl ether, mono, di, tributylene glycol monopentyl ether and mono, di, tributylene glycol monohexyl ether, ethylene glycol monoacetate and dipropylene glycol propionate. When these glycol type solvents may be incorporated at a level of from about 0.5 to about 10%, and more preferably about 0.5% to about 5%. While all of the aforementioned glycol ether compounds assist with cleaning, the most preferred include diethylene glycol monobutyl ether or diethylene glycol monomethyl ether. The preferred solvents for the present invention include ethanol, isopropanol, MP-Diol, the various glycol ether solvents and terpenes such as d-limonene or citrus oils such as orange oil, with the preferred levels of from about 0.5% to about 5% by weight in the composition.

Dyes, Fragrances, Preservatives, Etc.

The compositions of the present invention may also include fragrances or masking agents or fragrance accords that negate or make more pleasant the use of the abrasive cleansers. Fragrances may be added at levels recommended by the fragrance suppliers or that add a noticeable yet not overwhelming scent to the product.

Additionally, the compositions of the present invention may include various dyes, pigments or other colorants to make the mixture more attractive to the consumer, or to make it strongly colored enough to see where it has been applied and how much has been applied. For example, when cleaning white ceramic bathroom tile it may be desirable to use a cleanser that is not white colored and hence a composition with dye added may be more useful. Soluble dyes or pigments may be added at the levels necessary to impart a consumer perceivable and consumer preferred level of color but perhaps not so much as to stain white grout around bathroom tiles.

Conventional preservatives may be added to the compositions to improve shelf life by inhibiting mold and bacteria growth. The preferred preservatives are available from Rohm and Haas under the trade name of Kathon® or from Thor under the trade name Acticide®. For example, of particular use as a preservative for the liquid abrasive cleansers of the present invention is Acticide® MBS. Preferred use levels for the preservatives are as recommended by the manufacturers of these materials and communicated in their technical bulletins, or at the level that provides effective bacteria and mold inhibition. Optionally, ultraviolet-absorbing materials may be added to mitigate dye fading and other stability issues that are light induced. Such materials are available from Ciba. These materials are important when packaging the cleanser compositions of the present invention in packaging that does not provide for uv blocking.

Optional Electrolytes

The compositions of the present invention may also include various electrolytes to render visible improvements to the cleanser formula (e.g. add viscosity or to effect/modulate foam height/stability). Electrolytes that may find use here include the common chloride salts such as sodium, potassium, lithium, magnesium, calcium, zinc chloride and the like, and the sulfates such as sodium, magnesium or potassium sulfate. Such electrolytes may be added in any combination and preferably at a level of from about 0.01% to about 1% by weight of the total composition.

Compositions and Performance Data

TABLE 1 is a summary of various embodiments of the liquid abrasive cleanser compositions according to the present invention. This table delineates composition (in weight percent actives) along with some physical data such as viscosity, pH and physical (phase) stability and an overall acceptance rating. Some of these compositions represent preferred embodiments and these appear in the various cleaning performance and rinsing tests. For an example of wt. % active calculation and entry to the table below, incorporating 1.00% Aerodisp® W 7520 W as is will be listed in the table as “0.200” because this raw material is only 20% actives and 1% “as is” delivers 0.20 wt % actives.

TABLE 1
Liquid Abrasive Cleanser Formulations

| | Formulas (weight percent actives) | | | | | |
|---|---|---|---|---|---|---|
| Ingredients/Properties | 1 | 2 | 3 | 4 | 5 | 6 |
| Alcohol ethoxylate (Tomadol ® 600) | 4.000 | 4.000 | 4.000 | 4.000 | 4.000 | 4.000 |
| Monoethanolamine | 0.235 | 0.235 | 0.235 | 0.235 | 0.235 | 0.235 |
| Associative thickener (Acusol ® 820) | 0.120 | 0.120 | 0.120 | 0.120 | 0.120 | 0.120 |
| Calcium carbonate, ground | 37.50 | 37.50 | 37.50 | 37.50 | 37.50 | 37.50 |
| Fumed Silica (see key below) | 0.250^{a} | 0.250^{b} | 0.250^{c} | 0.100^{a} | 0.150^{a} | 0.150^{a} |
| Water, fragrance, dyes, preservatives | q.s. | q.s. | q.s. | q.s. | q.s. | q.s. |
| Viscosity (cps at 20 to 20.5° C.) | 11,440 | 11,760 | 13,600 | 20,600 | 29,080 | 19,280 |
| pH | 10.22 | 10.12 | 10.14 | 10.30 | 10.30 | 10.30 |
| Lather/Rinseability | Good/ | Good/ | Good/ | Good/ | Good/ | Good/ |
| | Good | Good | Good | Good | Good | Good |
| Overall Rating | Pass | Pass | Pass | Pass | Pass | Pass |

| | Formulas (weight percent actives) | | | |
|---|---|---|---|---|
| Ingredients/Properties | 7¹ | 8 | 9² | 10 |
| Alcohol ethoxylate (Tomadol ® 600) | 4.000 | 4.000 | 4.000 | 4.000 |
| Monoethanolamine | 0.235 | 0.235 | 0.235 | 0.235 |
| Associative thickener (Acusol ® 820) | 0.120 | 0.120 | 0.120 | 0.120 |
| Calcium carbonate, ground | 37.50 | 37.50 | 37.50 | 37.50 |
| Fumed Silica (see key below) | 0.160^{d} | 0.100^{d} | 0.160^{d} | 0.200^{d} |
| Water, fragrance, dyes, preservatives | q.s. | q.s. | q.s. | q.s. |
| Viscosity (cps at 20 to 20.5° C.) | 7,760 | 11,640 | 8,720 | 8,720 |
| pH | 10.21 | 10.60 | 10.65 | 10.57 |
| Lather/Rinseability | Good/ | Good/ | Good/ | Good/ |
| | Good | Good | Good | Good |
| Overall Rating | Pass | Pass | Pass | Pass |

Notes:
Formulas 7 and 9 differ only in order of addition, with ¹dispersed fumed silica added last;
²dispersed fumed silica added first to batch.
Ingredients Key: ^{a}Aerosil ® 300 fumed silica;
^{b}Aerosil ® 200 fumed silica;
^{c}Cab-O-Sil ® M5 fumed silica;
^{d}Aerodisp ® W 7520 N alkaline dispersed fumed silica.

From Table 1, Formula 1, which incorporates 0.25 wt. % Aerosil® 300 fumed silica, proved to be the most preferred composition within the scope of the compositions of the present invention. This composition was stable for 2-months at 4° C., 25° C., 40° C., and after repeated freeze/thaw cycles, and the composition still dispensed homogeneously even after extended storage without shaking. This preferred composition (Formula 1 from Table 1 above, herein designated “A”) was compared to a similar formula without fumed silica (herein designated “B”, and comprising the composition of formula 36 in Table 1 of U.S. Patent Application Publication 2010/0197557), and two readily available and widely marketed retail liquid cleansers (herein designated “C” and “D”), in various cleaning tests outlined below.

The soil removal tests included comparative tests for rust, soap scum, dirt, and various hardness soils. TABLE 2 reports the cleaning performance of products A, B, C, and D. The data is shown as “percent (%) soil removed” (as calculated from reflectance data according to standard test methods). Tests were adaptations of ASTM 4488-A3 (dirt/grime), D5343 (soap scum), D4482-A2 (kitchen greases), D4488-A3 (iron oxide grime), and Fed. Spec. #P-D-1747C (Outdoor soil), amongst other in-house and contract laboratory performance test methods. Kitchen grease soil removal was measured on painted wallboard. Iron oxide rust (per the ASTM method) removal was measured on vinyl composite. Outdoor soil removal was measured on vinyl siding. A separate man-made rust cleaning test was conducted on white, glazed ceramic tile. All studies utilized a Gardner Straight-Line Washability Apparatus and a reflectometer. Percent soil removal was calculated from the reflectance values before and after soiling and after cleaning, and the larger the number in the table, the “better” the cleaning. The general calculation is % soil removed=100(C−S)/(O−S), wherein C is reflectance of a subsequently cleaned specimen, S is the reflectance of a soiled and not yet cleaned specimen, and O is the reflectance of an unsoiled and “blank” specimen.

TABLE 2
Soil Removal Performance

| | Soap | Kitchen | Man-made | Iron | Outdoor |
|---|---|---|---|---|---|
| Sample | Scum | Greases | Rust | Oxide | Soil |
| A | 75.4 | 69.6 | 83.7 | 78.9 | 97.2 |
| B | 46.5 | 69.9 | 82.8 | 76.3 | 97.6 |
| C | 12.2 | 53.8 | 79.4 | 73.0 | 99.0 |
| D | 50.2 | 60.0 | 79.2 | 74.1 | 98.9 |

TABLE 3 reports the performance of samples A, B, C, and D on water harness, calcium carbonate deposits and lime scale.

TABLE 3
Hardness Removal Performance of liquid abrasive cleansers

| | % Soil Removed for Various Deposits | | |
|---|---|---|---|
| Sample | Water hardness | Calcium carbonate | Lime Scale |
| A | 88.1 | 89.7 | 87.8 |
| B | 85.0 | 89.0 | 88.8 |
| C | 83.4 | 72.4 | 74.5 |
| D | 83.9 | 79.6 | 78.1 |

Overall it appeared that a superior composition results from the combination of Acusol® 820 HASE thickener, Tomadol® 600 nonionic surfactant, and Aerosil® 300 silica. As evidenced by the cleaning performance difference between samples A (with silica) and B (without silica), particularly on soap scum soil, lead to a conclusion that addition of fumed silica improves cleaning performance. Not to be bound by any particular theory, it is believed that the silica further stabilizes the high solids matrix by increasing the suspension and anti-settling properties. The silica also appears to improve the overall rheological profile (i.e. the shear thinning upon shaking/dispensing with subsequent thickening and surface cling).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We have thus described a new liquid abrasive cleanser composition comprising a non cross-linked associative co-polymer thickener, silica, at least one water-dispersible nonionic surfactant, abrasives, a pH adjusting agent and water that overall outperforms two typical retail liquid abrasive cleansers and for soap scum soil outperforms a reference composition without the silica. It has been unexpectedly discovered that cross-linked polyacrylates are not required for stability of highly alkaline, high-abrasive suspensions and that rinseability can be greatly improved through the use of water-dispersible, rather than water-soluble, nonionic surfactants. Furthermore, it has been unexpectedly shown that silica improves the stability and the cleaning performance of liquid abrasive cleansers comprising non-cross linked, hydrophobically modified, associative thickeners.

We claim:

1. A liquid abrasive cleanser composition comprising:
a. from about 25% to about 40% of an abrasive;
b. from about 1.0% to less than about 5% by weight actives of a water-dispersible nonionic surfactant;
c. from about 0.1% to about 0.5% by weight actives of silica;
d. from about 0.05% to about 0.50% by weight actives of a non cross-linked associative co-polymer;
e. a pH adjusting agent; and,
f. water,
wherein the final pH of the composition is greater than 10.

2. The composition of claim 1, wherein said water-dispersible nonionic surfactant is an alcohol ethoxylate with HLB of about 10 or greater.

3. The composition of claim 1 further including an alkylpolyglycoside nonionic surfactant.

4. The composition of claim 1 further including at least one anionic surfactant chosen from the group consisting of sulfates, sulfonates, and fatty soaps, and mixtures thereof.

5. The composition of claim 1, wherein said associative co-polymer is an anionic co-polymer.

6. The composition of claim 1, wherein said abrasive is chosen from the list consisting of calcium carbonate, and talc, and mixtures thereof.

7. The composition of claim 1, wherein said alkaline agent is selected from the group consisting of sodium hydroxide, potassium hydroxide, magnesium hydroxide, ammonium hydroxide, ammonia, primary amines, secondary amines, tertiary amines, monethanolamine, diethanolamine, triethanolamine, sodium carbonate, potassium carbonate, sodium bicarbonate, potassium bicarbonate, sodium sesquicarbonate, sodium silicate, sodium borate, monosodium citrate, disodium citrate, and trisodium citrate, and mixtures thereof.

8. The composition of claim 1, wherein said silica is hydrophilic fumed silica.

9. A liquid abrasive cleanser composition comprising:
a. from about 25% to about 40% of calcium carbonate abrasive;
b. from about 1% to less than about 5% by weight actives of a water-dispersible alcohol ethoxylate nonionic surfactant having general formula R—(OCH₂CH₂)ₓ—OH, where R is C₁₀ to C₁₈, and where x is on average from 4 to 12 mol of ethylene oxide (EO);
c. from about 0.1% to about 0.5% by weight actives of fumed silica;
d. from about 0.05% to about 0.50% by weight actives of a non cross-linked anionic associative co-polymer;
e. a pH adjusting agent; and,
f. water,
wherein the final pH of the composition is greater than 10.

10. A liquid abrasive cleanser composition comprising:
a. from about 25% to about 40% of calcium carbonate abrasive;
b. from about 1% to less than about 5% by weight actives of a water-dispersible alcohol ethoxylate nonionic surfactant having general formula R—(OCH₂CH₂)ₓ—OH, where R is C₁₀ to C₁₈, and where x is on average from 4 to 12 mol of ethylene oxide (EO);
c. from about 0.1% to about 0.5% by weight actives of hydrophilic fumed silica;
d. from about 0.05% to about 0.50% by weight actives of an anionic non cross-linked associative co-polymer, said co-polymer comprising: a monoethylenically unsaturated monocarboxylic acid or dicarboxylic acid of from about 3 to 8 carbon atoms; a monoethylenically unsaturated acrylate ester; and an acrylic, or methacrylic, ethoxylated ester with general structure: H₂C═C(R)—C(O)—O—(CH₂—CH₂O)ₙ—R′, wherein R is either H or CH₃, R′ is C₈-C₂₄ and n is at least 2 and up to about 70;
e. a pH adjusting agent; and,
f. water,
wherein the final pH of the composition is greater than 10.

11. A liquid abrasive cleanser composition comprising:
a. from about 25% to about 40% of an abrasive selected from the group consisting of calcium carbonate and talc and mixtures thereof;
b. from about 1% to less than about 5% by weight actives of a water-dispersible alcohol ethoxylate nonionic surfactant having general formula R—(OCH₂CH₂)ₓ—OH, where R is C₁₀ to C₁₈, and where x is on average from 4 to 12 mol of ethylene oxide (EO);
c. from about 0.1% to about 0.5% by weight actives of hydrophilic fumed silica;
d. from about 0.05% to about 0.50% by weight actives of an anionic non cross-linked associative co-polymer, said co-polymer comprising: acrylic acid or methacrylic acid; ethylacrylate, ethyl methacrylate, methylacrylate, or methyl methacylate; and C₁₂-C₂₄ oxypolyethylmethacrylic having approximately 10-20 moles of ethylene oxide;
e. a pH adjusting agent; and,
f. water,
wherein the final pH of the composition is greater than 10.
